(19) United States
(12) Patent Application Publication
(10) Pub. No.: US 2006/0181874 A1
(43) Pub. Date: Aug. 17, 2006

(54) Decorative light bulb

(76) Inventors: Chin-Li Tsai, Hsinchu (TW); Ching-Chu Chen, Hsinchu (TW); Shu-Mei Tai, Hsinchu (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/059,764

(22) Filed: Feb. 17, 2005

(51) Int. Cl. F21V 14/00

(52) U.S. Cl. 362/255; 362/293

(57) ABSTRACT

A decorative bulb has a body, a transparent adhesive layer and a nonwoven coating. The transparent adhesive layer is applied to and covers the body. The nonwoven coating is applied on and covers the transparent adhesive layer to decorate the body and is easily applied to the transparent adhesive layer. When the bulb is bumped, the transparent adhesive layer and the nonwoven coating keep the bulb from being broken.

### BACKGROUND OF THE INVENTION

1. Field of the Invention

The present invention relates to a light bulb, especially to a decorative light bulb.

2. Description of the Prior Arts

Decorative bulbs are used to decorate trees, walls, doors, etc. The conventional decorative bulb comprises a bulb and a colored holder. The colored holder is mounted around the bulb to make the bulb more colorful. However, the colored holders have to be manufactured separately. After manufacturing the colored holders, the colored holders have to be mounted around the bulbs. Manufacturing and mounting the colored holders is more expensive and time-consuming.

To overcome the shortcomings, the present invention provides an improved decorative bulb to mitigate or obviate the aforementioned problems.

### SUMMARY OF THE INVENTION

The main objective of the present invention is to provide a decorative bulb that is easily manufactured. The decorative bulb has a body, a transparent adhesive layer and a nonwoven coating. The transparent adhesive layer is applied to and covers the body. The nonwoven coating is applied to and covers the transparent adhesive layer to decorate the body and is easy to apply to the transparent adhesive layer. The transparent adhesive layer and the nonwoven coating strengthen the bulb so the bulb is less likely to break when the bulb is bumped or dropped.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a bulb;

FIG. 2 is a perspective view of a decorative bulb in accordance with the present invention;

FIG. 3 is a side view in partial section of the decorative bulb in FIG. 2; and

FIG. 4 is an internal side view of an application chamber of an electrostatic machine.

### DETAILED DESCRIPTION OF THE PREFERRED EMBODIMENTS

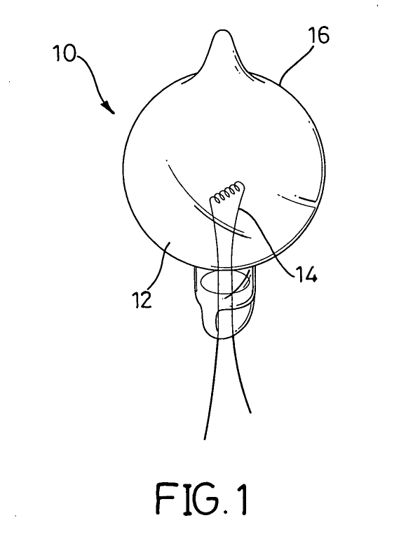

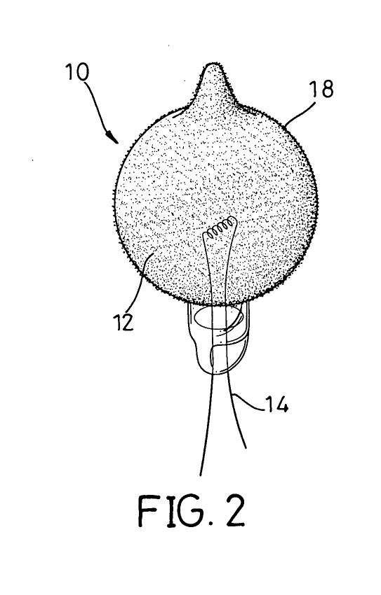

With reference to FIGS. 1 and 2, a decorative bulb in accordance with the present invention comprises a body (10), a transparent adhesive layer (16) and a nonwoven coating (18).

The body (10) has a bottom, an outer wall (12) and a filament with leads (14). The filament with leads (14) is mounted in the body (10) and extends out from the bottom of the body (10).

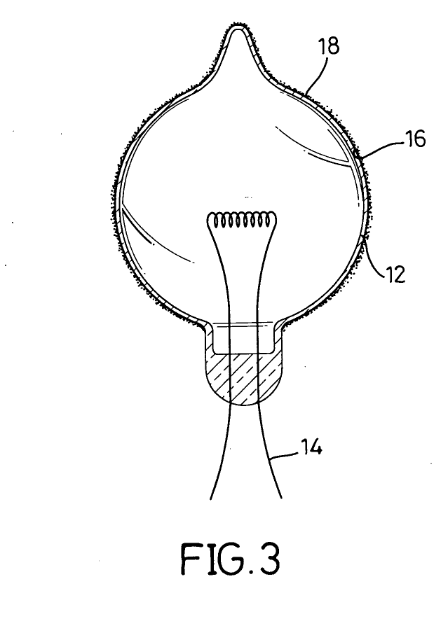

With further reference to FIG. 3, the transparent adhesive layer (16) is applied to and covers the outer wall (12) of the body (10) and may be a hydrophilic glue.

The nonwoven coating (18) is applied to and covers the transparent adhesive layer (16), is minute particles and may be applied by an electrostatic technique. The minute particles may be synthetic or natural fibers or material.

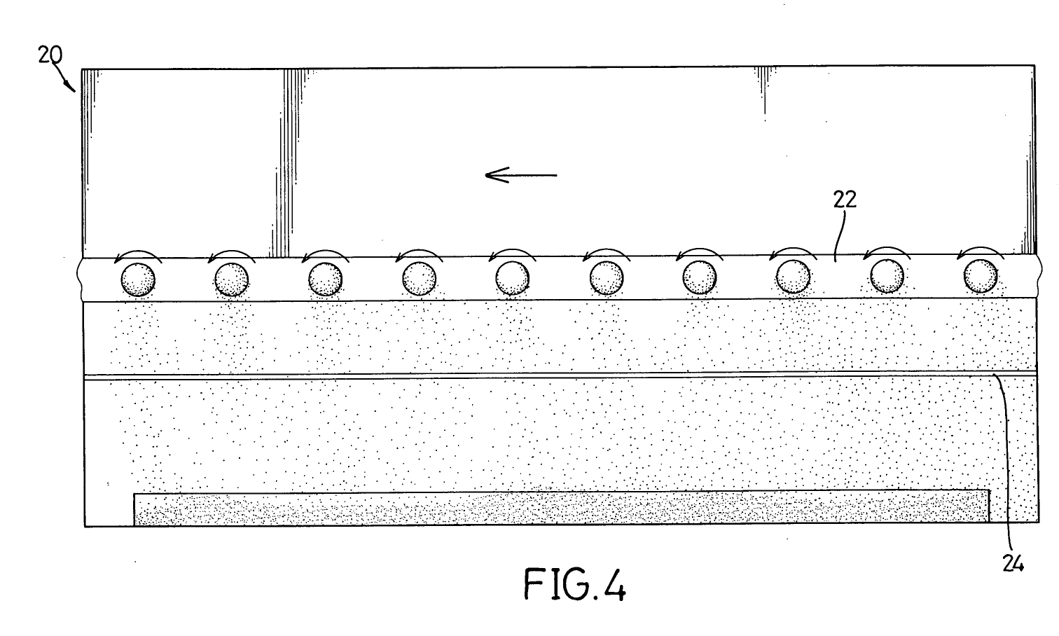

With further reference to FIG. 4, an electrostatic machine (20) to apply the nonwoven coating (18) to the adhesive layer (16) on the outer wall (12) of the body (10) of a bulb comprises an application chamber, a transport belt (22) and an electrostatic net (24). The application chamber has a bottom, an inlet and an outlet. The transport belt (22) is an endless belt mounted through the application chamber, moves from the inlet to the outlet, rotates and applies a positive charge to objects mounted on the belt. The electrostatic net (24) is mounted in the machine (20) under the transport belt (22) and is charged with static electricity. The minute particles are placed in the bottom of the machine (20), acquire a negative charge from the static electricity in the electrostatic net (24), become agitated due to the size of the particles and the negative charge, float upward and to bond to the transparent adhesive layer (16) on the decorative bulb. The rotation of the decorative bulb and the floating of the fabric particles cause the minute particles to bond uniformly to the transparent adhesive layer (16) on the bulb.

The decorative bulb as described has numerous advantages. The nonwoven coating (18) decorates the bulb and is easy to bond to the bulb. When the bulb is bumped, the transparent adhesive layer (16) and the nonwoven coating (18) keep the bulb from being broken.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A decorative bulb comprising
a body having
a bottom;
an outer wall; and
a filament with leads mounted in the body and extending out from the bottom of the body;
a transparent adhesive layer applied to and covering the outer wall of the body; and
a nonwoven coating applied to and covering the transparent adhesive layer and being particles.

2. The decorative bulb as claimed in claim 1, wherein the transparent adhesive layer is a hydrophilic glue.

3. The decorative bulb as claimed in claim 1, wherein the nonwoven coating is applied by an electrostatic technique.

4. The decorative bulb as claimed in claim 2, wherein the nonwoven coating is applied by an electrostatic technique.

5. The decorative bulb as claimed in claim 1, wherein the minute particles are synthetic fibers.

6. The decorative bulb as claimed in claim 1, wherein the minute particles are natural fibers.

7. The decorative bulb as claimed in claim 1, wherein the minute particles are synthetic material.

8. The decorative bulb as claimed in claim 1, wherein the minute particles are natural material.

9. The decorative bulb as claimed in claim 4, wherein the minutes particles are synthetic fibers.

10. The decorative bulb as claimed in claim 4, wherein the minute particles are natural fibers.

11. The decorative bulb as claimed in claim 4, wherein the minute particles are synthetic material.

12. The decorative bulb as claimed in claim 4, wherein the minute particles are natural material.
